(19) United States
(12) Patent Application Publication
(10) Pub. No.: US 2006/0225092 A1
(43) Pub. Date: Oct. 5, 2006

(54) Control apparatus and image receiving apparatus

(75) Inventors: Toshihiro Takagi, Osaka (JP); Toshiya Iwahashi, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/358,504

(22) Filed: Feb. 21, 2006

(30) Foreign Application Priority Data
Mar. 8, 2005 (JP) 2005-063577

(51) Int. Cl. H04N 5/445; H04N 5/50

(52) U.S. Cl. 725/38; 348/564; 348/731

(57) ABSTRACT

A receiving apparatus allowing a user to easily recognize whether input of channel number has been completed or not is provided. The receiving apparatus includes an input portion accepting a user instruction, an OSD generating a signal to display a channel number, a CPU controlling the OSD to generate a signal to display the channel number in a manner specific to a special time period during the special time period from the time when the input portion accepts an instruction to start input of channel number to the time when a condition for determining that the input of the channel number has been completed is satisfied, and to generate a signal to display the channel number in a manner different from the manner specific to the special time period during a time period other than the special time period, and an output portion outputting the signal generated by the OSD.

### BACKGROUND OF THE INVENTION

1. Field of the Invention

The present invention relates to a control apparatus and an image receiving apparatus, and more particularly to a control apparatus for a receiver circuit and an image receiving apparatus.

2. Description of the Background Art

Japanese Patent Laying-Open No. 2002-344843 discloses a digital broadcast receiver provided with a tuner portion that selects a signal of a desired frequency from digital broadcast signals received from an antenna, and a demodulation and correction portion that demodulates the received signal and corrects errors in the signal and detects the receiving state of the received signal. The receiver visually displays the receiving state detected by the demodulation and correction portion, from the start of channel selection until the end of decoding of the video image.

According to this invention, it is possible to recognize the receiving state of a selected channel until a picture is displayed after channel selection.

Japanese Patent Laying-Open No. 2002-077760 discloses an information processing apparatus controlling display of an EPG (Electric Program Guide). It controls display such that a past program having its broadcast time earlier than the current time, a program having its broadcast time including the current time, and a future program having its broadcast time later than the current time are displayed in different colors.

According to this invention, the program currently being broadcast, the program having already been broadcast, and the program to be broadcast can be distinguished at a glance.

Japanese Patent Laying-Open No. 2002-335458 discloses a digital television receiver provided with a circuit that sequentially receives a plurality of broadcast waves, demodulates a transport stream from each broadcast wave, and measures the reception strength in each transport stream, a circuit that stores in a memory each channel information in each transport stream by linking the reception strength of each channel measured in the units of the transport streams to each channel information, and a circuit that reads each channel information from the memory and displays a list of channels on a screen of a display device such that channel display parts are displayed in different forms in accordance with the reception strengths of the respective channels stored in the memory in the linked manner.

According to this invention, it is possible to accurately and efficiently select a channel with the good reception state from the channel list.

The inventions disclosed in Japanese Patent Laying-Open Nos. 2002-344843, 2002-077760 and 2002-335458 described above, however, do not give any consideration to a problem that in the future it may become more difficult for a user to determine whether input of channel number has been completed or not. The number of channels viewable on a signal television set continues to increase, although the number of channels actually watched by one user is limited. A technique for enabling a user to efficiently select a desired channel from among a large number of channels is required. The procedure for selecting channels will become complicated if it is attempted to efficiently select a desired channel from among a large number of channels, and it may become increasingly difficult for a user to determine whether channel selection has been completed or not. At present, the number of channels viewable on a signal television set is not so large, which is considered to be a reason that makes it difficult to recognize the problem that determination as to whether channel selection has been completed or not may become difficult (or, the reason why none of Japanese Patent Laying-Open Nos. 2002-344843, 2002-077760 and 2002-335458 described above has addressed this problem).

### SUMMARY OF THE INVENTION

The present invention has been made to solve the above-described problem. An object of the present invention is to provide a control apparatus and an image receiving apparatus that enable a user to easily recognize whether input of channel number has been completed or not.

To achieve the above-described object, according to an aspect of the present invention, a control apparatus includes: an accepting portion for accepting an instruction from a user; a generating portion for generating a signal to display a channel number; a first control unit for controlling the generating portion to generate a signal to display the channel number in a display color specific to a special time period during the special time period from the time when the accepting portion has accepted an instruction to start an input of a channel number to the time when a condition for determining that the input of the channel number has been completed is satisfied; a second control unit for controlling the generating portion to generate a signal to display the channel number in a display color different from the display color specific to the special time period during a time period other than the special time period; and an output portion for outputting the signal generated by the generating portion.

That is, the generating portion generates a signal to display a channel number. The first control unit controls the generating portion to generate a signal to display the channel number in a display color specific to a special time period during the special time period. The second control unit controls the generating portion to generate a signal to display the channel number in a display color different from the display color specific to the special time period during a time period other than the special time period. The output portion outputs the signal generated by the generating portion. This configuration makes it possible to display the channel number in the display color specific to the special time period or in a different display color, according to whether it is during the special time period or not. As a result, it is possible to provide a control apparatus that allows a user to significantly easily recognize whether the input of channel number has been completed or not.

According to another aspect of the present invention, a control apparatus includes: an accepting portion for accepting an instruction from a user; a generating portion for generating a signal to display a channel number; a first control unit for controlling the generating portion to generate a signal to display the channel number in a manner specific to a special time period during the special time period from the time when the accepting portion has accepted an instruction to start an input of a channel number to the time when a condition for determining that the input of the channel number has been completed is satisfied; a second control unit for controlling the generating portion to generate a signal to display the channel number in a manner different from the manner specific to the special time period during a time period other than the special time period; and an output portion for outputting the signal generated by the generating portion.

That is, the generating portion generates a signal to display a channel number. The first control unit controls the generating portion to generate a signal to display the channel number in a manner specific to a special time period during the special time period. The second control unit controls the generating portion to generate a signal to display the channel number in a manner different from the manner specific to the special time period during a time period other than the special time period. The output portion outputs the signal generated by the generating portion. This configuration makes it possible to display the channel number in the manner specific to the special time period or in a different manner, according to whether it is during the special time period or not. As a result, it is possible to provide a control apparatus that allows a user to significantly easily recognize whether the input of channel number has been completed or not.

Preferably, the above-described manner includes a visually recognizable manner.

That is, the first control unit controls the generating portion to generate a signal to display the channel number in a visually recognizable manner specific to the special time period during the special time period. The second control unit controls the generating portion to generate a signal to display the channel number in a visually recognizable manner that is different from the manner specific to the special time period, during a time period other than the special time period. This enables visual recognition of the special time period. Since it is possible to visually recognize whether it is during the special time period or not, it is possible to more easily recognize whether the input of channel number has been completed or not. As a result, a control apparatus that allows a user to more easily recognize whether input of channel number has been completed or not can be provided.

Preferably, the visually recognizable manner described above includes a manner of a display color.

That is, the first control unit controls the generating portion to generate a signal to display the channel number in a display color specific to the special time period during the special time period. The second control unit controls the generating portion to generate a signal to display the channel number in a display color different from the display color specific to the special time period, during a time period other than the special time period. This enables recognition of the special time period by the display color. Since it is possible to recognize whether it is during the special time period or not with the display color, it is possible to significantly easily recognize whether the input of channel number has been completed or not. As a result, a control apparatus that allows a user to significantly easily recognize whether input of channel number has been completed or not can be provided.

According to yet another aspect of the present invention, an image receiving apparatus preferably includes the control apparatus described above.

That is, it is possible to provide an image receiving apparatus that allows a user to easily recognize whether input of channel number has been completed or not.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an overall configuration diagram of a receiving apparatus according to an embodiment of the present invention.

FIGS. 2-4 are flowcharts illustrating control procedure of main number setting processing according to the embodiment of the present invention.

FIGS. 5-7 are flowcharts illustrating control procedure of sub-number setting processing according to the embodiment of the present invention.

FIG. 8 shows a screen of a TV receiver according to the embodiment of the present invention before a channel number is accepted.

FIG. 9 shows a screen of the TV receiver according to the embodiment of the present invention when a number of the ten's place is input.

FIG. 10 shows a screen of the TV receiver of the embodiment of the present invention when “-” is input.

FIG. 11 shows a screen of the TV receiver of the embodiment of the present invention when a number of the ten's place of the sub-number is input.

FIG. 12 shows a screen of the TV receiver of the embodiment of the present invention when input of the sub-number is completed.

### DESCRIPTION OF THE PREFERRED EMBODIMENTS

Hereinafter, an embodiment of the present invention will be described with reference to the drawings. In the following, the same portions have the same reference characters allotted, and have the same names and functions. Therefore, detailed description thereof will not be repeated where appropriate.

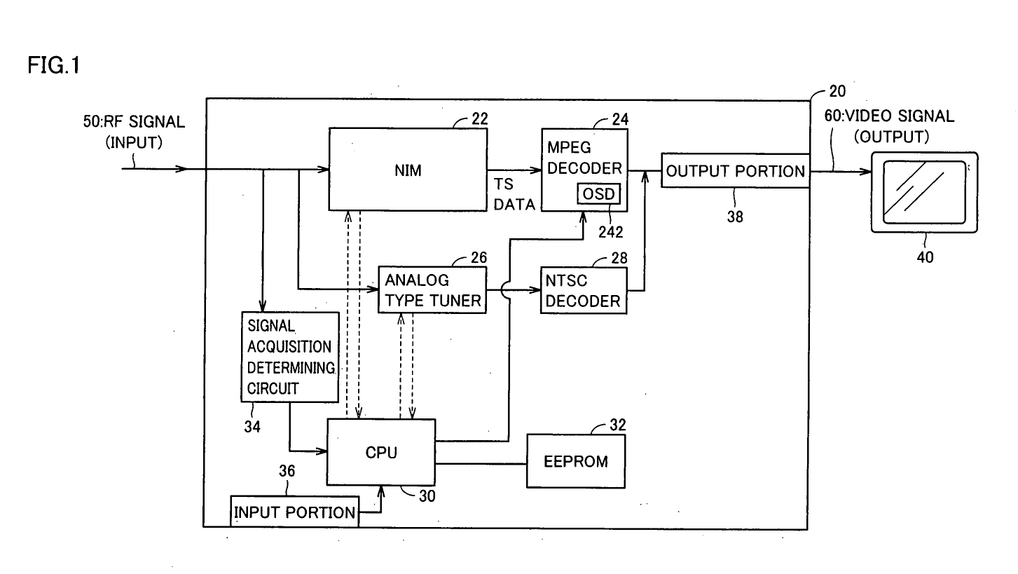

FIG. 1 shows a configuration of a receiving apparatus 20 according to an embodiment of the present invention. Receiving apparatus 20 receives and processes a RF (Radio Frequency) signal 50 constituting a high-frequency signal from a not-shown input terminal (in the case of the present embodiment, the input terminal may be connected to an antenna or to a terminal outputting a signal of a cable television), and outputs a video signal 60 to an externally connected TV (Television) receiver 40 so that the received broadcast can be watched on TV receiver 40 (herein, TV receiver 40 operates as a device displaying a video image using the video signal converted by a MPEG (Motion Picture Experts Group) decoder 24 as will be described later). Receiving apparatus 20 is herein shown as a STB (Set Top Box) (i.e., as a control apparatus) arranged separately from TV receiver 40. Alternatively, receiving apparatus 20 may be incorporated into TV receiver 40 (i.e., an image receiving apparatus incorporating receiving apparatus 20 may be provided). Further, the analog TV broadcast signal, which is shown as a NTSC (National Television Standards Committee) signal according to the NTSC scheme, is not limited to the signal of this scheme.

Referring to FIG. 1, receiving apparatus 20 includes a processing unit for DTV (Digital Television) broadcasting, a processing unit for analog TV broadcasting of the NTSC signal, a CPU (Central Processing Unit) 30 for controlling the various parts of receiving apparatus 20, an EEPROM (Electrically Erasable and Programmable Read Only Memory) 32 for storing data, a signal acquisition determining circuit 34, an input portion 36, and an output portion 38.

The processing unit for the DTV broadcasting includes a NIM (Network Interface Module) 22 for receiving and processing RF signal 50 and outputting computer-processible TS (Transport Stream) data to thereby extract a broadcast signal from the digital waves, and a MPEG decoder 24 for receiving and decoding the TS data according to the MPEG scheme (i.e., converting the broadcast signal extracted by NIM 22 to a video signal), and outputting video signal 60. The processing unit for the analog TV broadcasting includes an analog type tuner 26 for receiving RF signal 50 and performing a tuning operation (in the case of the present embodiment, operation of determining whether a periodic signal can be detected or not) to thereby extract a broadcast signal from the analog waves, and a NTSC decoder 28 for decoding the broadcast signal extracted by the tuning operation of analog type tuner 26 according to the NTSC scheme, and outputting video signal 60. MPEG decoder 24 and NTSC decoder 28 are devices that output the broadcast signals extracted by the corresponding tuners, NIM 22 and analog type tuner 26, respectively.

Receiving apparatus 20 may receive at least one of a RF signal of the terrestrial broadcasting and a RF signal of the CATV (Cable Television) broadcasting as RF signal 50.

CPU 30 controls the respective parts of receiving apparatus 20. EEPROM 32 stores data necessary for CPU 30 to control receiving apparatus 20.

Signal acquisition determining circuit 34 in FIG. 1 outputs acquisition result information indicating that an 8 VSB (Vestigial Sideband Modulation) signal has been acquired when waveform spectrum characteristic to the 8 VSB scheme is detected in RF signal 50 input to receiving apparatus 20. When waveform spectrum characteristic to the QAM (Quadrature Amplitude Modulation) scheme is detected, it outputs acquisition result information indicating that a QAM signal has been acquired. Upon detection of waveform spectrum characteristic to the NTSC signal, it outputs acquisition result information indicating that a NTSC signal has been acquired. If none of these waveform spectra is detected, it outputs acquisition result information indicating that no signal has been acquired. The acquisition result information output is provided to CPU 30.

Input portion 36 receives information from a user via a key input. The information received may include a channel number of the type used for the analog broadcasting and a channel number of the type used for the digital broadcasting. The information received is provided to CPU 30.

Output portion 38 is a circuit for externally outputting the signal output from at least one of MPEG decoder 24 (including an OSD (On Screen Display) 242) and NTSC decoder 28.

MPEG decoder 24 includes OSD 242, which, when receiving the content and display color of the character to be displayed on TV receiver 40 from CPU 30, generates a signal to display the character on TV receiver 40. The generated signal is output from output portion 38 to TV receiver 40, which then displays an image of the character based on the output signal.

In receiving apparatus 20 according to the present embodiment, auto scan can be carried out, where (receiving) channels are automatically assigned for the broadcast signals of the receivable broadcast stations. Receiving apparatus 20 is capable of receiving any of digital terrestrial broadcasting, digital CATV broadcasting, analog terrestrial broadcasting, and analog CATV broadcasting. Thus, it is necessary to determine, prior to the auto scan, which of the following, the broadcast signal of the terrestrial broadcasting or that of the CATV broadcasting, receiving apparatus 20 is configured to receive through the antenna or the cable connected thereto, and then carry out the auto scan in accordance with the connection manner thus determined.

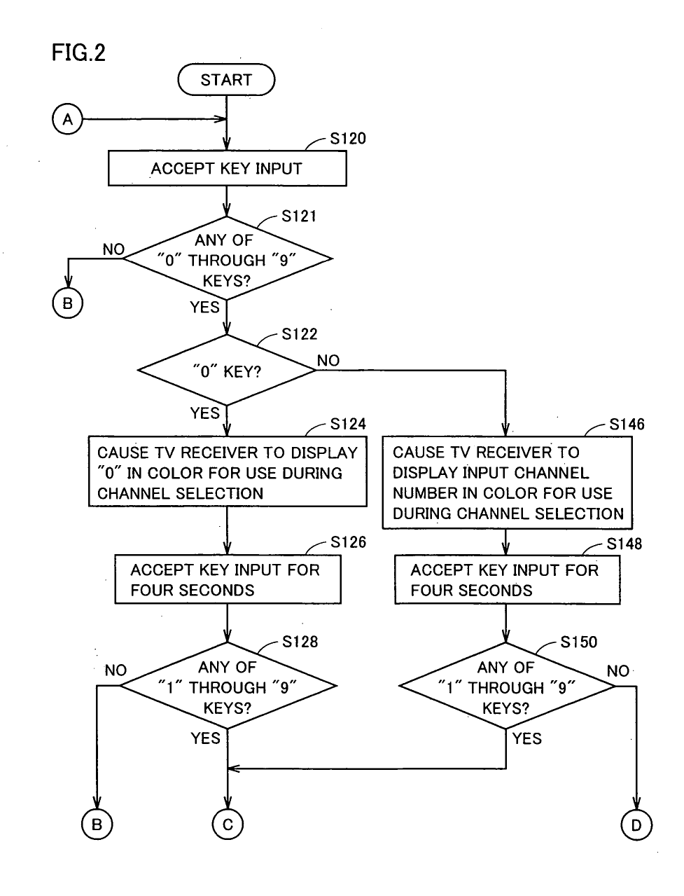

Referring to FIGS. 2-4, a program executed by receiving apparatus 20 performs the following control regarding channel number setting.

In step (hereinafter, abbreviated as “S”) 120, input portion 36 accepts a key input from a user. The information accepted via the key input is provided to CPU 30.

In S121, CPU 30 determines whether there was a key input of any of “0” through “9” keys. If it is determined that there was the input of any of the “0” through “9” keys (YES in S121), the process proceeds to S122. If not (NO in S121), the process proceeds to S144.

In S122, CPU 30 determines whether there was a key input of the “0” key or not. If it is determined that there was the input of the “0” key (YES in S122), the process proceeds to S124. If not (NO in S122), the process proceeds to S146. In S124, CPU 30 causes TV receiver 40 to display “0” in a color for use during channel selection. In S126, input portion 36 accepts a key input for four seconds.

In S128, CPU 30 determines whether there was a key input of any of the “1” through “9” keys. If it is determined that there was the input of any of the “1” through “9” keys (YES in S128), the process proceeds to S130. If not (NO in S128), the process proceeds to S144.

In S130, CPU 30 causes the number (channel number), corresponding to the key input made, to be displayed in the color for use during channel selection. In S132, input portion 36 accepts a key input for four seconds.

In S134, CPU 30 determines whether there was a key input of any of the “0” through “9” keys. If it is determined that there was the input of any of the “0” through “9” keys (YES in S134), the process proceeds to S136. If not NO in S134), the process proceeds to S138.

In S136, CPU 30 determines whether the channel number accepted in S120-S132 is within a range (in the present embodiment, the “range” means a range predetermined as the channel numbers). If it is determined that it is within the range (YES in S136), the process proceeds to S132. If not (NO in S136), the process proceeds to S120.

In S138, CPU 30 determines whether there was a key input of a “-” key. If it is determined that there was the input of the “-” key (YES in S138), the process proceeds to S140. If not (NO in S138), the process proceeds to S142. In S140, input portion 36 and CPU 30 accept the sub-number setting. This processing corresponds to processes in S162-S188, which will be described later.

In S141, CPU 30 determines whether to cancel the application of the channel selection or not. If it is determined to cancel the channel selection (YES in S141), the process proceeds to S144. If not (NO in S141), the process proceeds to S156.

In S142, CPU 30 determines whether there was no key input at input portion 36 or whether there was a key input of a decision key. If it is determined that there was no key input or there was the input of the decision key (YES in S142), the process proceeds to S156. If not (NO in S142), the process proceeds to S144.

In S144, CPU 30 cancels the channel selection, and changes the color of the channel number to a color for use during standby. In S146, CPU 30 causes TV receiver 40 to display the input channel number in the color for use during channel selection. In S148, input portion 36 accepts a key input for four seconds.

In S150, CPU 30 determines whether there was a key input of any of the “1” through “9” keys. If it is determined that there was the input of any of the “1” through “9” keys (YES in S150), the process proceeds to S130. If not (NO in S150), the process proceeds to S152.

In S152, CPU 30 determines whether there was a key input of the “-” key. If it is determined that there was the input of the “-” key (YES in S152), the process proceeds to S140. If not (NO in S152), the process proceeds to S154.

In S154, CPU 30 determines whether there was no key input or whether there was a key input of the decision key. If it is determined that there was no key input or there was the input of the decision key (YES in S154), the process proceeds to S156. If not (NO in S154), the process proceeds to S144. In S156, CPU 30 changes the color of the channel number to the color for use during standby.

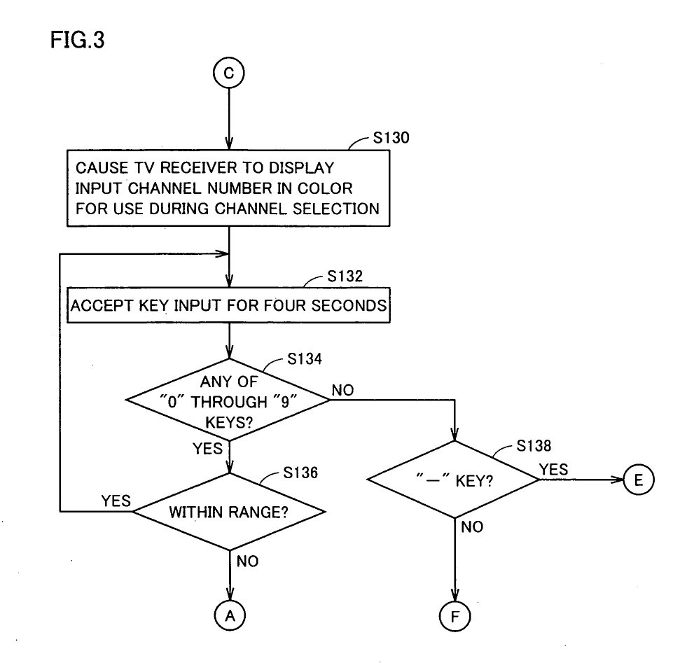

Referring to FIGS. 5-7, a program executed by receiving apparatus 20 regarding the sub-number setting processing has the following control structure.

In S162, CPU 30 causes TV receiver 40 to display “-” in the color for use during channel selection, following the channel number already input. In S164, input portion 36 accepts a key input for four seconds.

In S166, CPU 30 determines whether there was a key input of the “0” key. If it is determined that there was the input of the “0” key (YES in S166), the process proceeds to S168. If not (NO in S166), the process proceeds to S174. In S168, CPU 30 causes TV receiver 40 to display “0” in the color for use during channel selection, following the “-” already displayed. In S170, input portion 36 accepts a key input for four seconds.

In S172, CPU 30 determines whether there was a key input of any of the “1” through “9” keys. If it is determined that there was the input of any of the “1” through “9” keys (YES in S172), the process proceeds to S173. If not (NO in S172), the process proceeds to S188. In S173, CPU 30 causes TV receiver 40 to display the channel number corresponding to the key input made, in the color for use during channel selection.

In S174, CPU 30 determines whether there was a key input of any of the “1” through “9” keys. If it is determined that there was the input of any of the “1” through “9” keys (YES in S174), the process proceeds to S176. If not (NO in S174), the process proceeds to S188.

In S176, CPU 30 causes TV receiver 40 to display the channel number corresponding to the key input made, in the color for use during channel selection, following the channel number already displayed. In S178, input portion 36 accepts a key input for four seconds.

In S180, CPU 30 determines whether there was a key input of any of the “0” through “9” keys. If it is determined that there was the input of any of the “0” through “9” keys (YES in S180), the process proceeds to S182. If not (NO in S180), the process proceeds to S184. In S182, CPU 30 causes TV receiver 40 to display the channel number corresponding to the key input made, in the color for use during channel selection, following the channel number already displayed.

In S184, CPU 30 determines whether there was no key input at input portion 36 or whether there was a key input of the decision key. If it is determined that there was no key input or there was the input of the decision key (YES in S184), the process is terminated. If not (NO in S184), the process proceeds to S186. In S186, CPU 30 performs setting to cancel the channel selection. The processing for canceling the channel selection is not particularly restricted. In the case of the present embodiment, it is assumed that CPU 30 sets a flag for canceling the channel selection.

In S188, CPU 30 determines whether there was no key input or whether there was a key input of the decision key. If it is determined that there was no key input or there was the input of the decision key (YES in S188), the process is terminated. If not (NO in S188), the process proceeds to S186.

Hereinafter, an operation of receiving apparatus 20 based on the above-described structure and flowcharts will be described.

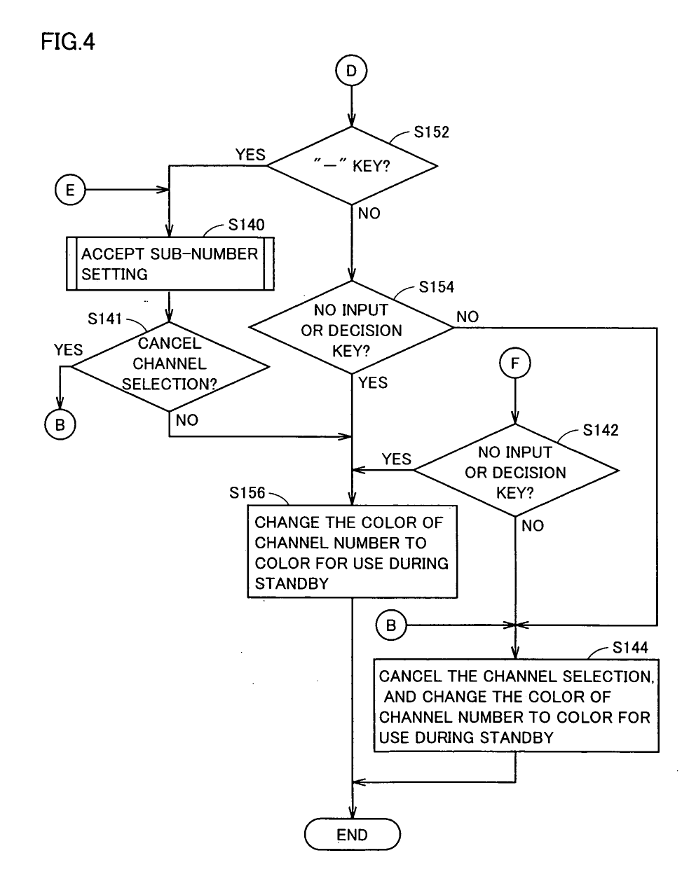

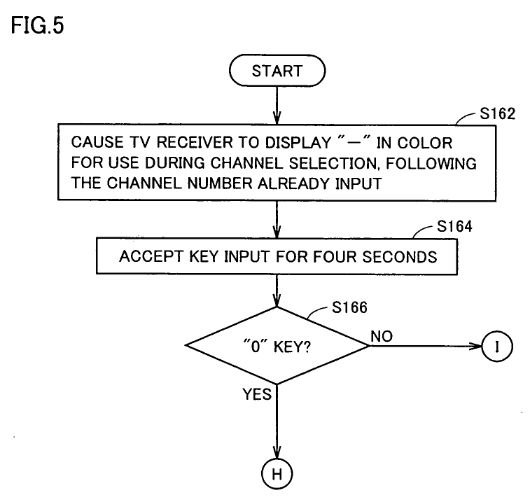

Input portion 36 accepts a key input from a user (S120). FIG. 8 shows a screen of TV receiver 40 at this time point (the outline characters in FIG. 8 show that the channel number is being displayed in a bright color (yellow in the case of the present embodiment)). When the key input is accepted, CPU 30 determines whether there was a key input of any of the “0” through “9” keys (S121). In the case of the present embodiment, when input portion 36 accepts the input of any of the “0” through “9” keys while receiving a broadcast, CPU 30 determines that input portion 36 has accepted an instruction to start input of a channel number. In the case of the present embodiment, a special time period is started at the time when input portion 36 accepts the instruction to start the input of the channel number. The “special time period” in the present embodiment refers to the time period from the time when input portion 36 has accepted the instruction to start the input of the channel number to the time when a condition for determining that the input of the channel number has been completed is satisfied. The “conditions for determining that the input of the channel number has been completed” in the present embodiment will be described later. In the present embodiment, the special time period is terminated when any of the “conditions for determining that the input of the channel number has been completed” is satisfied. In this case, assume that there was a key input of the “1” key (YES in S121). CPU 30 determines whether there was a key input of the “0” key or not (S122). Since the key input was not the “0” key (NO in S122), CPU 30 causes TV receiver 40 to display the input channel number in the color for use during channel selection (S146). At this time, OSD 242 of MPEG decoder 24 generates a signal to display the channel number in a display color specific to the special time period. CPU 30 controls OSD 242 to generate the signal to display the channel number in the display color specific to the special time period. Output portion 38 outputs the signal generated by OSD 242. FIG. 9 shows a screen of TV receiver 40 on which the input channel number “1” is displayed.

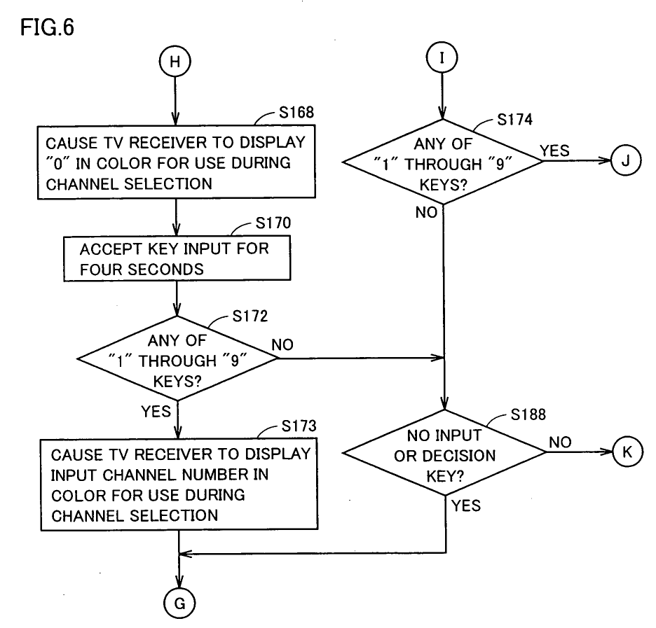

When the channel number is displayed, input portion 36 accepts a key input for four seconds (S148). When the key input is accepted, CPU 30 determines whether there was a key input of any of the “1” through “9” keys (S150). In this case, if there was the input of the “9” key (YES in S150), CPU 30 causes the channel number to be displayed in the color for use during channel selection (S130). When the channel number is displayed, input portion 36 accepts a key input for four seconds (S132). When the key input is accepted, CPU 30 determines whether there was a key input of any of the “0” through “9” keys (S134). In this case, assume that there was the input of the “-” key (NO in S134). CPU 30 determines whether there was a key input of the “-” key or not (S138). In this case, since the key input was the “-” key (YES in S138), CPU 30 causes TV receiver 40 to display “-” in the color for use during channel selection, following the channel number already input (S162). FIG. 10 shows a screen of TV receiver 40 when “-” is displayed.

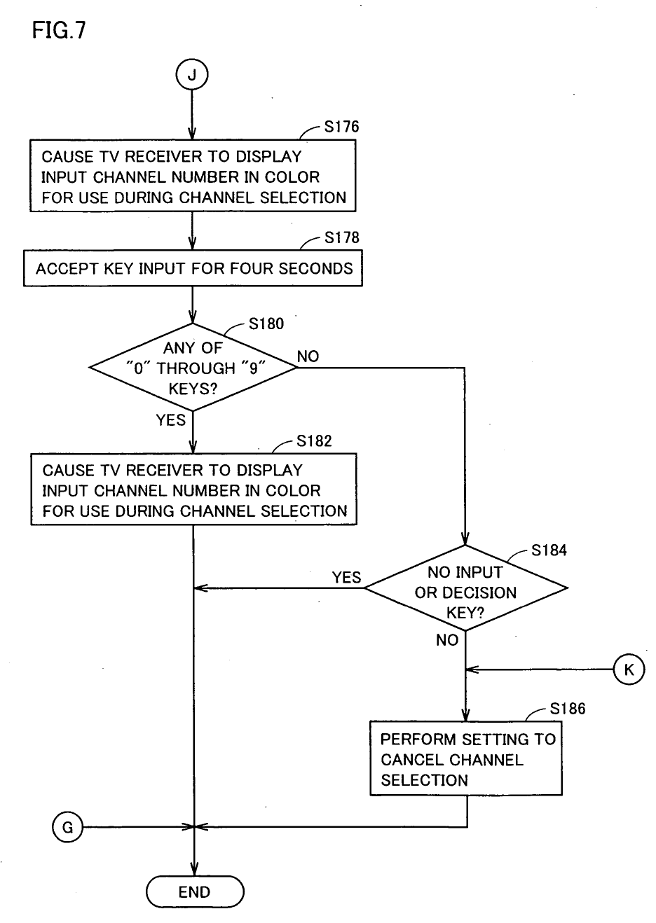

When “-” is displayed, input portion 36 accepts a key input for four seconds (S164). When the key input is accepted, CPU 30 determines whether there was a key input of the “0” key or not (S166). In this case, assume that the key input was the “0” key (YES in S166). CPU 30 then causes TV receiver 40 to display “0” in the color for use during channel selection, following “-” already displayed (S168). FIG. 11 shows a screen of TV receiver 40 on which “0” is displayed.

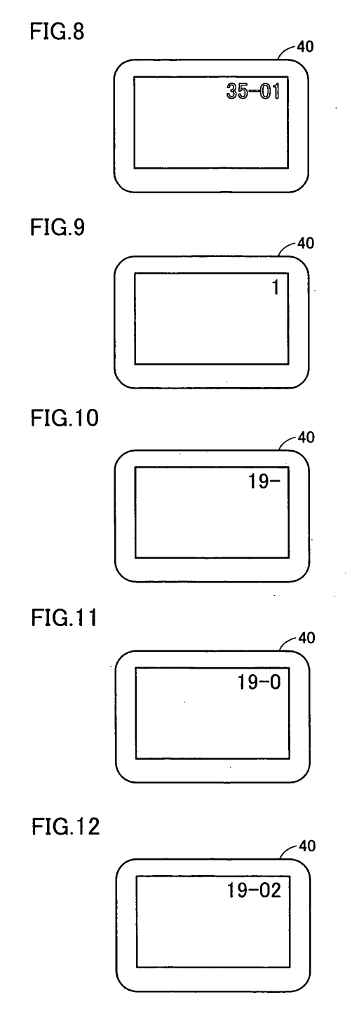

When “0” is displayed, input portion 36 accepts a key input for four seconds (S170). When the key input is accepted, CPU 30 determines whether there was a key input of any of the “1” through “9” keys (S172). In this case, assume that the “2” key was input (YES in S172). CPU 30 then causes TV receiver 40 to display the channel number corresponding to the key input made, in the color for use during channel selection (S173). FIG. 12 shows a screen of TV receiver 40 on which the channel number “2” corresponding to the key input made is displayed. At this time (i.e., when the number of digits of the channel number displayed on the screen becomes a prescribed number or more), the special time period is terminated (it enters a time period different from the special time period), since one of the “conditions for determining that the input of the channel number has been completed” (i.e., that the number of digits of the channel number displayed on the screen becomes a prescribed number or more) is satisfied. In the case of the present embodiment, the special time period is also terminated when the key input in S170 is the decision key, since one of the “conditions for determining that the input of the channel number has been completed” (i.e., that the decision key is input) is satisfied. Conducting the process in S144 is also one of the “conditions for determining that the input of the channel number has been completed” in the present embodiment.

When the channel number is displayed, CPU 30 determines whether to cancel the application of the channel selection or not (S141). In this case, assume that the channel selection is finished normally (i.e., not “cancelled” to neglect the application of the channel selection) (NO in S141). CPU 30 then changes the color of the channel number to the color for use during standby (S156). OSD 242 of MPEG decoder 24 generates a signal to display the channel number in a color different from the display color specific to the special time period. CPU 30 controls OSD 242 to generate the signal to display the channel number in the color different from the display color specific to the special time period. Output portion 38 outputs the signal generated by OSD 242.

As described above, the receiving apparatus according to the present embodiment differentiates the color of the channel number displayed on the TV receiver during the channel number setting, from the color of the channel number displayed on the TV receiver during the remaining time. That is, when a channel number is being input for direct channel selection, the display color of the channel number is changed before and after establishment of the selected channel. This allows the user to easily and clearly recognize whether the channel number is being set or not (whether the input of the channel number has been completed or not). In the receiving apparatus of the present embodiment, the effect is significant particularly when receiving broadcasting having a complicated channel number configuration like the digital broadcasting. Further, the receiving apparatus of the present embodiment is suitable for mass-production, since it can be manufactured through the step of storing the programs executed by the CPU in the EEPROM, among others. As a result, it is possible to provide a control apparatus suitable for mass-production and permitting easy recognition as to whether the channel number is being set or not. Furthermore, it is possible to provide the receiving apparatus and the TV receiver of the present embodiment (when TV receiver 40 incorporates receiving apparatus 20, that TV receiver) as an image receiving apparatus suitable for mass-production and permitting easy recognition as to whether the channel number is being set or not.

It is noted that receiving apparatus 20 is not restricted to the STB. For example, receiving apparatus 20 may be a DVD (Digital Versatile Disk) recorder or a hard disk recorder.

Further, the format of the channel accepted by receiving apparatus 20 is not particularly restricted. For example, the main number may have three digits. For example, the sub-number may also have three digits. The main number alone may be input. In the case where the main number alone is to be input, the steps S138, S140, S152 and S160-S188 may be omitted. Receiving apparatus 20 may determine the format of the channel to be accepted (particularly, the maximum numbers of digits of the main number and the sub-number) at the time of the auto scan.

Still further, instead of the signal to display in a display color specific to the special time period or instead of the signal to display in a color different from the display color specific to the special time period, a signal to display in a manner specific to the special time period or a signal to display in a manner different from the manner specific to the special time period may be generated. In this case, the manner specific to the special time period and the manner different from the manner specific to the special time period preferably include a visually recognizable manner (which may be a font of the channel number, an outer frame or the like, besides the display color).

Furthermore, instead of OSD 242 of MPEG decoder 24, CPU 30 may generate a signal to output the channel number in a manner specific to the special time period or a signal to output the channel number in a manner different from the manner specific to the special time period. The manner specific to the special time period and the manner different from the manner specific to the special time period may include a sound represented as a part of video signal 60.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A control apparatus, comprising:
an accepting portion for accepting an instruction from a user;
a generating portion for generating a signal to display a channel number;
a first control unit for controlling said generating portion to generate a signal to display said channel number in a display color specific to a special time period during said special time period from the time when said accepting portion has accepted an instruction to start an input of a channel number to the time when a condition for determining that the input of the channel number has been completed is satisfied;
a second control unit for controlling said generating portion to generate a signal to display said channel number in a display color different from the display color specific to said special time period during a time period other than said special time period; and
an output portion for outputting the signal generated by said generating portion.

2. A control apparatus, comprising:
an accepting portion for accepting an instruction from a user;
a generating portion for generating a signal to display a channel number;
a first control unit for controlling said generating portion to generate a signal to display said channel number in a manner specific to a special time period during said special time period from the time when said accepting portion has accepted an instruction to start an input of a channel number to the time when a condition for determining that the input of the channel number has been completed is satisfied;
a second control unit for controlling said generating portion to generate a signal to display said channel number in a manner different from the manner specific to said special time period during a time period other than said special time period; and
an output portion for outputting the signal generated by said generating portion.

3. The control apparatus according to claim 2, wherein said manner includes a visually recognizable manner.

4. The control apparatus according to claim 3, wherein said visually recognizable manner includes a manner of a display color.

5. An image receiving apparatus including the control apparatus as recited in claim 2.
